(19) United States
(12) Patent Application Publication
(10) Pub. No.: US 2005/0093362 A1
(43) Pub. Date: May 5, 2005

(54) Oscillating wheel accessory

(76) Inventor: Jorge Alicea, Jacksonville, FL (US)

Correspondence Address: Mark J. Young;McGuireWoods LLP, Suite 3300, 50 North Laura Street, Jacksonville, FL, 32202, US

(21) Appl. No.: 10/698,559

(22) Filed: Oct. 31, 2003

(51) Int. Cl. B60B 7/04

(52) U.S. Cl. 301/37.25; 301/37.101

(57) ABSTRACT

An oscillator or spinner assembly includes an accessory mount configured for securing to the lugs of a wheel. A removable decorative oscillator is mounted to the accessory mount using mounting bolts. A bearing assembly is provided to facilitate rotation of the oscillator. Weights may be affixed to various portions of the oscillator to achieve desired rotational effects. By securing the oscillator assembly to a wheel using the wheel's lugs, it is unnecessary to remove wheels for installing and removing the oscillator assembly. Additionally, the oscillator or spinner may be readily changed without requiring removal of the wheels. Furthermore, the decorative oscillator or spinner may readily be changed without removal of the wheel and without removal of the entire assembly.

### BACKGROUND OF THE INVENTION

1. Field of the Invention

This invention generally relates to wheel oscillating accessories that allow independent rotation of a wheel oscillator relative to wheel rotational speed, and, more particularly, to an oscillator that is easily removable and replaceable and that can be made not to move when the vehicle is in motion.

2. Background Description

Wheel oscillating devices, also known as spinners, are well known familiar sights on automobiles and trucks. Such devices typically include a decorative oscillator rotatably mounted through a central aperture of a wheel. A bearing mounted between the wheel and spinner decouples wheel rotation from oscillator movement. The result is a mesmerizing display of relative motions, including a slowly rotating oscillator that makes a fast moving vehicle appear to be moving slowly, or a rotating oscillator that makes a stationary wheel appear to be moving.

Unfortunately, conventional oscillators suffer several drawbacks. One shortcoming involves the assembly. Typically, vehicle wheels must be removed to install conventional oscillators. Conventional devices are assembled using a bolt that passes through central apertures of the oscillator and a wheel, and a nut that attaches to the threaded end of the bolt passing through to the backside of the wheel. As installing and removing the nut requires removal of the wheel, the conventional assembly makes installation, removal and replacement laborious.

Another shortcoming of conventional oscillators is an inability to remain stationary while the vehicle wheel is moving. Instead, conventional oscillators rotate, albeit at a different speed than the wheel, when the vehicle is moving. A stationary oscillator would provide a new pleasant illusion for observers, making the vehicle's wheels seem stationary although the vehicle is in motion.

Yet another shortcoming of conventional spinners is that they are designed for specific vehicles. Thus, a spinner designed for a first vehicle may not be useful for a second vehicle of a different make, model or year. Manufacture of such spinners for a wide range of vehicles substantially increases manufacturing costs.

The invention overcomes one or more of the problems in conventional oscillators as set forth above.

### SUMMARY OF THE INVENTION

An exemplary oscillator or spinner assembly in accordance with the principles of the invention includes an accessory mount configured for securing to the lugs of a wheel. A removable decorative oscillator is mounted to the accessory mount using mounting bolts. A bearing assembly is provided to facilitate rotation of the oscillator. Weights may be affixed to various portions of the oscillator to achieve desired rotational effects. By securing the oscillator assembly to a wheel using the wheel's lugs, it is unnecessary to remove wheels for installing and removing the oscillator assembly. Additionally, the oscillator or spinner may be readily changed without requiring removal of the wheels. Furthermore, the decorative oscillator or spinner may readily be changed without removal of the entire assembly.

In one embodiment, an oscillating wheel assembly is provided for attachment to a wheel having a plurality of wheel lugs. The oscillating wheel assembly includes a means for mounting the assembly to two or more of the plurality of wheel lugs. The assembly also includes a means for facilitating rotational motion of an attached structure. The means for facilitating rotational motion is operably coupled to the means for mounting. Additionally, the assembly includes an oscillator (or spinner) operably coupled to the means for facilitating rotational motion.

In another embodiment the means for mounting includes an accessory mount. The accessory mount has a plurality of apertures near the periphery of the mount. The apertures are sized and configured to receive the plurality of wheel lugs. Additionally, the means for facilitating rotational motion includes a bearing assembly. The bearing assembly is operably coupled to the means for mounting. The spinner is rotatably coupled to the bearing assembly.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate preferred embodiments of the invention and, together with the detailed description, serve to explain the principles of the invention. In the drawings:

FIG. 1 illustrates an exemplary oscillating wheel accessory attached to a vehicle wheel;

FIG. 2 illustrates a front view of an exemplary decorative oscillator;

FIG. 3 illustrates an exploded view of an exemplary oscillating wheel assembly in accordance with an embodiment of the invention;

FIG. 4 illustrates a cross-sectional, assembled view of an exemplary oscillating wheel assembly of FIG. 3;

FIG. 5 illustrates a cross-sectional, exploded view of an exemplary oscillating wheel assembly with attachments to a vehicle wheel;

FIG. 6 illustrates a cross-sectional, assembled view of another exemplary oscillating wheel assembly with attachments to a vehicle wheel;

FIG. 7 illustrates an exploded view of an exemplary oscillating wheel assembly in accordance with an embodiment of the invention;

FIG. 8 illustrates an exploded view of another exemplary oscillating wheel assembly in accordance with an embodiment of the invention; and

FIGS. 9A through 9C illustrate an exemplary universal accessory mount for use with an oscillator assembly according to the principles of the invention.

### DETAILED DESCRIPTION

An exemplary oscillator in accordance with the principles of the invention includes an accessory mount configured for securing to the lugs of a wheel. A removable decorative oscillator is rotatably mounted to the accessory mount. Weights may be affixed to various portions of the oscillator to achieve desired rotational effects.

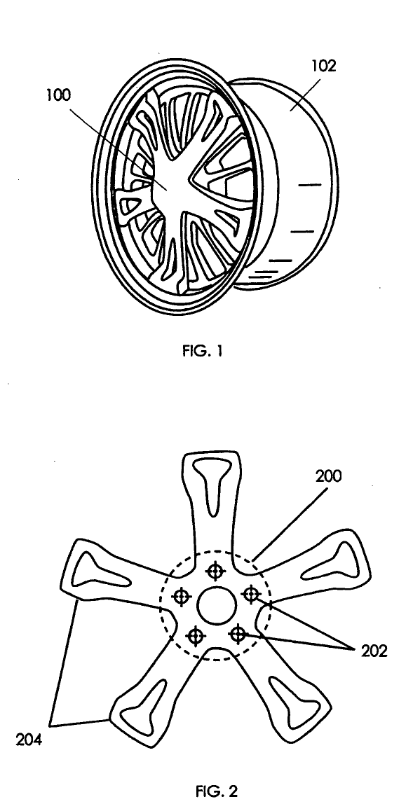

Referring now to FIG. 1, an oscillating wheel accessory 100 according to the principles of the present invention is shown. The oscillating wheel accessory 100 is mountable to a wheel 102, as described in further detail below.

Referring now to FIG. 2, a front view of an exemplary decorative oscillator 200 is shown. The oscillator may be comprised of a metal, metal alloy, composite, plastic or a combination of any of the foregoing. Preferably, the material is strong, durable, weather resistant and capable of withstanding stresses and temperatures experienced by automotive wheels. The material should also be cost effective and suitable for manufacture using conventional manufacturing techniques.

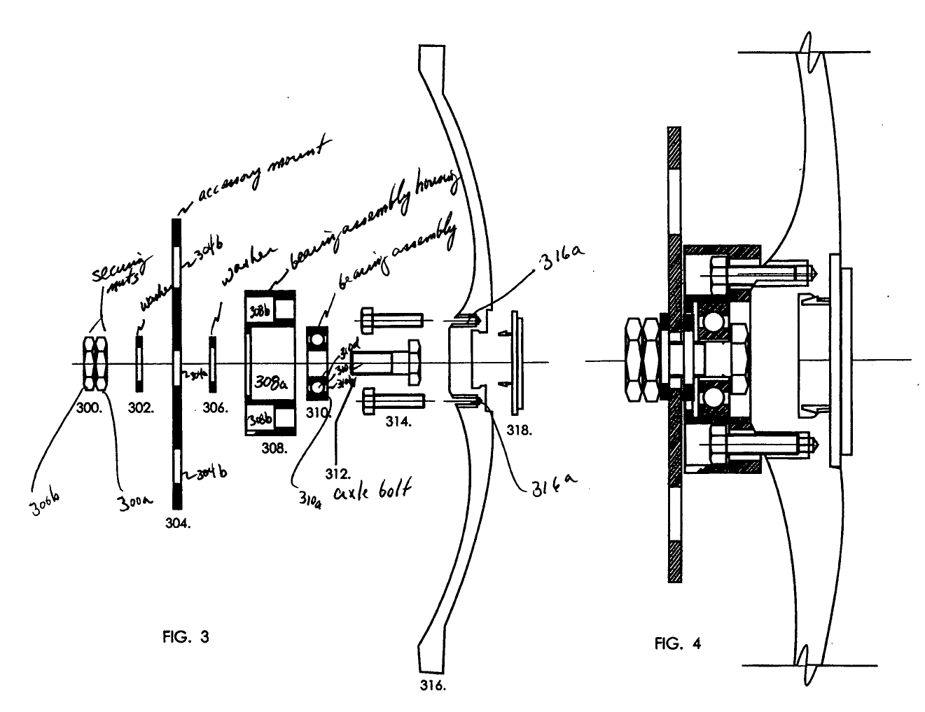

The exemplary oscillator 200 includes a plurality of spokes 204, though other configurations and designs are feasible without departing from the scope of the present invention. A plurality of threaded bolt holes 202 are provided, such as at the base of each spoke on the rear side of the decorative oscillator 202 wherein the oscillator mount screws 314 (FIG. 3) may be threadedly inserted, as discussed more fully below. The oscillator may also contain a central indentation or cavity suitable for receiving a center cap.

A plurality of weights (not shown), such as ¼ ounce weights, may be affixed to the spokes to influence response of the decorative oscillator while the wheel rotates, accelerates, decelerates and comes to a stop. By way of example and not limitation, each weight may be comprised of a metallic strip and an adhesive backing, or other mechanical attachment device, for securing the metallic strip to the back of the decorative oscillator. Illustratively, one or more weights may be attached to the back of one or more spokes of the oscillator. The weights may be configured to weigh down a portion of the oscillator to resist rotational motion. Alternatively, the weights may be distributed evenly to enhance the rotational momentum of the oscillator. Those skilled in the art will appreciate that other weight distributions and rotational effects are readily feasible using such selectively applied weights.

Referring now to FIG. 3, exemplary components of a first embodiment of an oscillator assembly in accordance with the principles of the invention are shown. The oscillator assembly includes an accessory mount 304 having a central opening 304a suitable for securely accommodating an axle bolt 312, and a plurality of peripheral openings 304b for engaging wheel lugs. The bearing assembly may have a disc shape or other geometric configuration suitable for accommodating the central opening 304a and peripheral openings 304b. The accessory mount 304 may be comprised of a metal such as steel or aluminum, a metal alloy, a composite material, a plastic or a combination of any of the foregoing. The material should be strong, durable, weather resistant and capable of withstanding stresses and temperatures experienced by automotive wheels. The material should also be cost effective and suitable for manufacture using conventional manufacturing techniques.

The oscillator assembly also includes a bearing assembly 310. The bearing assembly 310 may be comprised of a conventional wheel bearing. By way of example and not limitation, a bearing comprised of an outer race 310a, roller bearings 310b, a cage 310c and an inner race 310d may be used. The center of the bearing includes an aperture for receiving axle bolt 312. Grease (not shown) may be applied to the bearing assembly in a conventional manner to lubricate the roller bearings.

A bearing assembly housing 308 provides for correct bearing alignment and releasable rotatable attachment of the decorative oscillator to the accessory mount. The housing 308 includes a cavity 308a for securely receiving the bearing assembly 310. The bearing assembly 310 should enable rotational motion within the bearing housing cavity 308a. The housing 310 also includes a plurality of holes 308b for receiving bolts or screws 314 to attach the decorative oscillator 316 to the bearing assembly housing 310. The bolts or screws 314 may thread into corresponding threaded holes 316a of the decorative oscillator 316.

An axle bolt 312 and one or more securing nuts 300 may be used to secure the bearing assembly housing 308 containing the bearing assembly 310 to the accessory mount 304. Washers 306 and 302 may be placed between the bearing assembly housing 308 and accessory mount 304, as well as between the accessory mount 304 and the one or more securing nuts 300. The threaded end of the axle bolt 312 passes through the center aperture of the bearing assembly 310, through the outer washer 306, through the center aperture of the accessory mount 304, and through the inner washer 302. The securing nuts 300 engage the threaded end of the axle bolt 312.

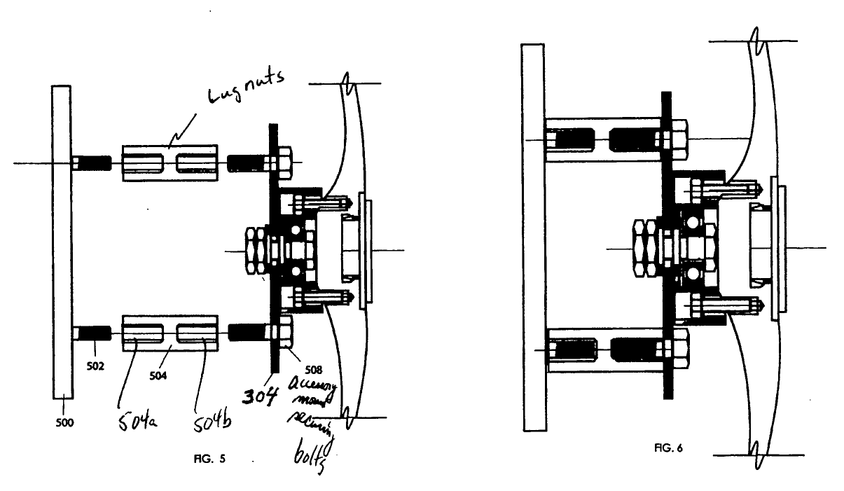

To assemble an oscillator assembly in accordance with the principles of the invention, first the bearing assembly 310 is inserted into the bearing assembly housing 308. Next the threaded end of the axle bolt is slipped through the bearing assembly and out through the back of the bearing assembly housing 308. Next, the threaded ends of the bolts or screws 314 are passed through the holes 308 in the bearing assembly housing and threaded into the cooperating holes 316a of the decorative oscillator 316. Next, the threaded end of the axle bolt 312 may be passed through the outer washer 306, the central aperture 304a of the accessory mount 304, and the inner washer 302. A first securing nut 300a may then be threaded onto the threaded end of the axle bolt 312. A second securing nut 300b may also be threaded onto the threaded end of the axle bolt 312. The second threaded nut 300b locks the first threaded nut 300a in place. An assembled oscillator assembly in accordance with a first embodiment of the invention is shown in FIG. 4.

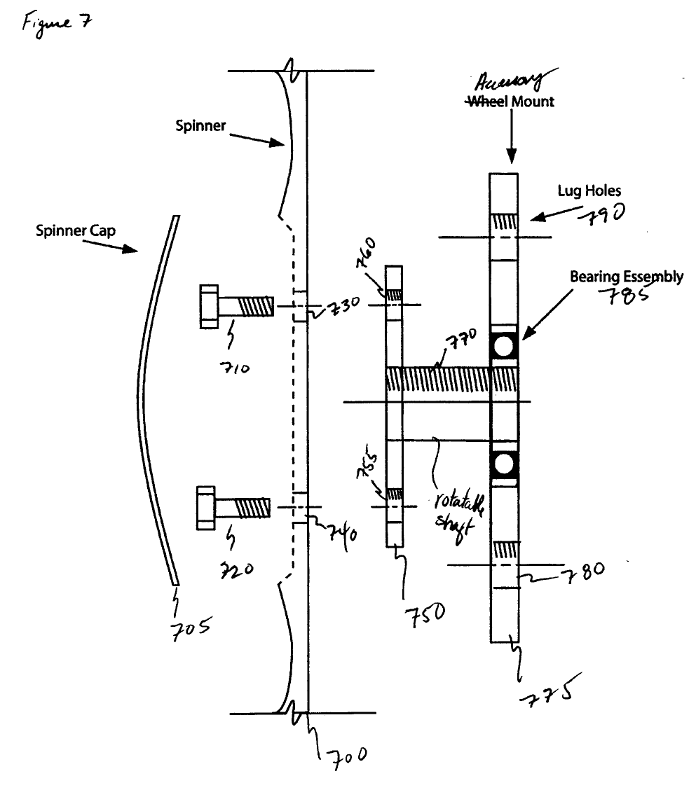

Referring now to FIG. 5, after assembling an oscillator assembly in accordance with the principles of the invention, as described above, the assembled unit may be attached to a wheel 102. A plurality of lug couplings 504 are used to secure accessory mount securing bolts 508 to wheel lugs 502. Each lug coupling includes an inner female threaded end configured to receive the male threaded end of a wheel lug, and an outer female threaded end configured to receive the male threaded end of accessory mount securing bolts 508. The inner ends 504a of the lug couplings 504 may first be threaded onto the wheel lugs 502. Next, the threaded ends of the accessory mount securing bolts 508 may be inserted through peripheral openings 304b of the accessory mount 304, and threaded into the outer threaded ends 504b of the lug couplings 504. Each accessory mount securing bolts 508 may be tightened by engaging its head with a suitably sized wrench placed in between the back of the spinner and the front of the wheel. Alternatively, the spinner may include one or more apertures or spaces between spokes to facilitate engaging and tightening the head of each accessory mount securing bolts 508 using a suitably sized socket wrench. An assembled oscillator assembly in accordance with a first embodiment of the invention is shown attached to a wheel in FIG. 6.

Those skilled in the art will appreciate that the bearing assembly housing 308 serves as a mount to which the decorative oscillator 316 is removably attached. The decorative oscillator 316 may be removed from lo the bearing assembly housing 308 by removing the plurality of bolts or screws 314. The bearing assembly housing 308 may be removed from the accessory mount 304 by removing axle bolt 312. The accessory mount 304 may be removed from the wheel 102 by removing lug nuts, as discussed below. The lug nuts 504 may be accessed with a wrench for removal in the space between the decorative oscillator 316 and the wheel 102.

In an alternative embodiment of an oscillator according to the principles of the invention, threaded ends of a plurality of oscillator mounting bolts 314 may pass through a plurality of apertures through the decorative oscillator. The heads of the oscillator mounting bolts 314 may be on the outer surface of the decorative oscillator. The bearing assembling housing may contain a plurality of threaded holes for securely receiving the threaded ends of the oscillator mounting bolts 314. The oscillator mounting bolts 314 may be securely threaded into the plurality of threaded holes. The cap 318 may be configured to conceal the heads of the oscillator mounting bolts 314.

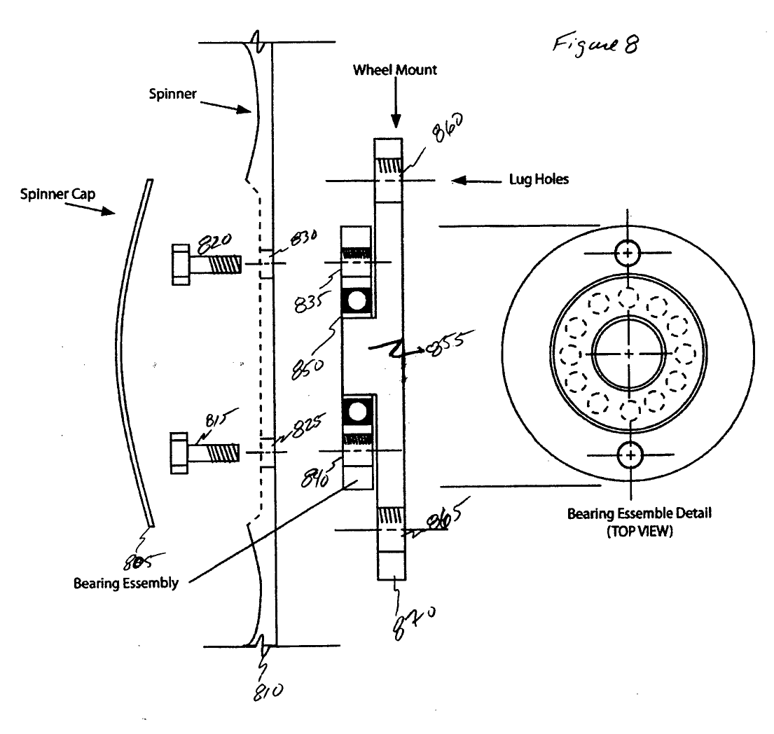

Referring now to FIG. 7, another embodiment of an oscillator according to the principles of the invention is conceptually shown. In this embodiment, a bearing assembly 785 is housed in an accessory mount 775. The bearing assembly 785 may have flanges for secure attachment to the accessory mount 775. A shaft 770 is rotatably attached to the bearing assembly 785 in a conventional manner, such as by using a nut, bolt and washers. The accessory mount 775 includes peripheral lug holes 780 and 790 for receiving the threaded ends of wheel lugs (not shown in FIG. 7). The wheel lugs may then be bolted to the accessory mount 775. Threaded ends of a plurality of oscillator mounting bolts 710 and 720 may pass through a plurality of apertures 730 and 740 through the decorative oscillator 700. The heads of the oscillator mounting bolts 710 and 720 may abut the outer surface of the decorative oscillator 700. A flange 750 attached to the rotatable shaft 770 may contain a plurality of threaded holes 755 and 760 for securely receiving the threaded ends of the oscillator mounting bolts 710 and 720. The oscillator mounting bolts 710 and 720 may be securely threaded into the plurality of threaded holes 755 and 760. The cap 705 may be configured to conceal the heads of the oscillator mounting bolts 710 and 720.

Referring now to FIG. 8, yet another embodiment of an oscillator according to the principles of the invention is conceptually shown. In this embodiment, a flanged bearing assembly 850 is rotatably mounted on a protruding shaft (or collar) 855 of an accessory mount 870. The bearing assembly 850 may have flanges with threaded holes 835 and 840 for receiving oscillator mounting bolts 815 and 820. Wheel lugs (not shown in FIG. 8) may be bolted to the accessory mount 870. Threaded ends of the plurality of oscillator mounting bolts 815 and 820 may pass through a plurality of apertures 825 and 830 through the decorative oscillator 810. The heads of the oscillator mounting bolts 815 and 820 may abut the outer surface of the decorative oscillator 810. The flange portion of the bearing assembly, which contains a plurality of threaded holes 835 and 840, securely receives the threaded ends of the oscillator mounting bolts 815 and 820. The oscillator mounting bolts 815 and 820 may be securely threaded into the plurality of threaded holes 835 and 840. The cap 805 may be configured to conceal the heads of the oscillator mounting bolts 815 and 820.

A common thread between the various embodiments described above is the use of a mounting means, such as, for example, an accessory mount with lug nuts or bolts and lug couplers, to secure an oscillator assembly to a wheel using the wheel's lugs. Means for mounting an oscillator assembly to a wheel using the wheel's lugs other than those described above, such as devices having different geometric configurations than those described above may also be used and come within the scope of the present invention.

Another common thread is that the mounting means directly or indirectly supports a means for facilitating rotational motion of a spinner, such as a bearing assembly with attachment means for attaching the bearing assembly to the mounting means in a conventional manner. Means for facilitating rotational motion of a spinner, other than the bearing assemblies described above, such as devices having different geometric configurations, housings and mountings than those described above may also be used and come within the scope of the present invention.

A further common thread is that the spinner or oscillator is attached directly or indirectly to the means for facilitating rotational motion. Means for attachment, other than the bearing assemblies, bearing housings and flanges described above, such as devices having different geometric configurations than those described above may also be used and come within the scope of the present invention.

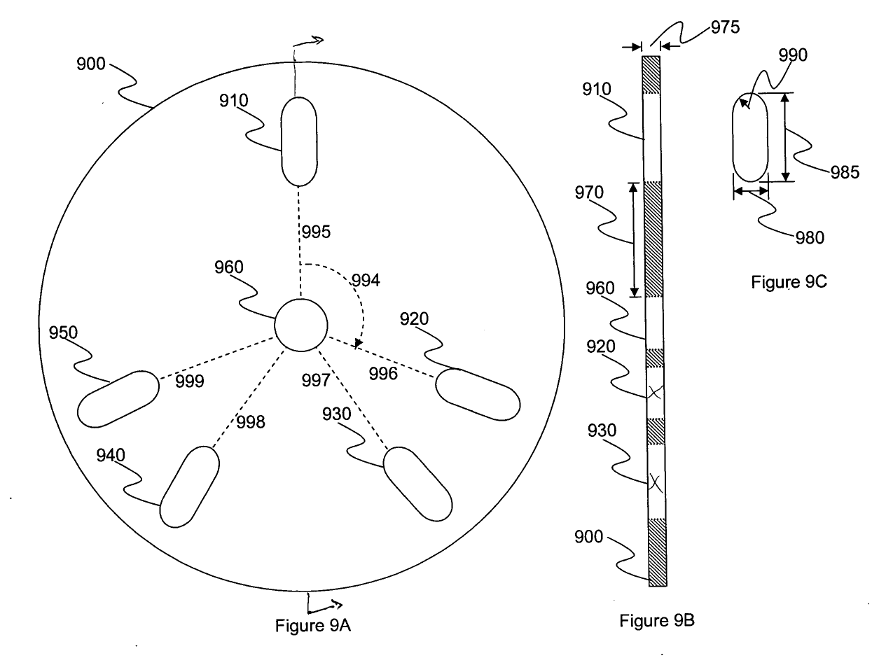

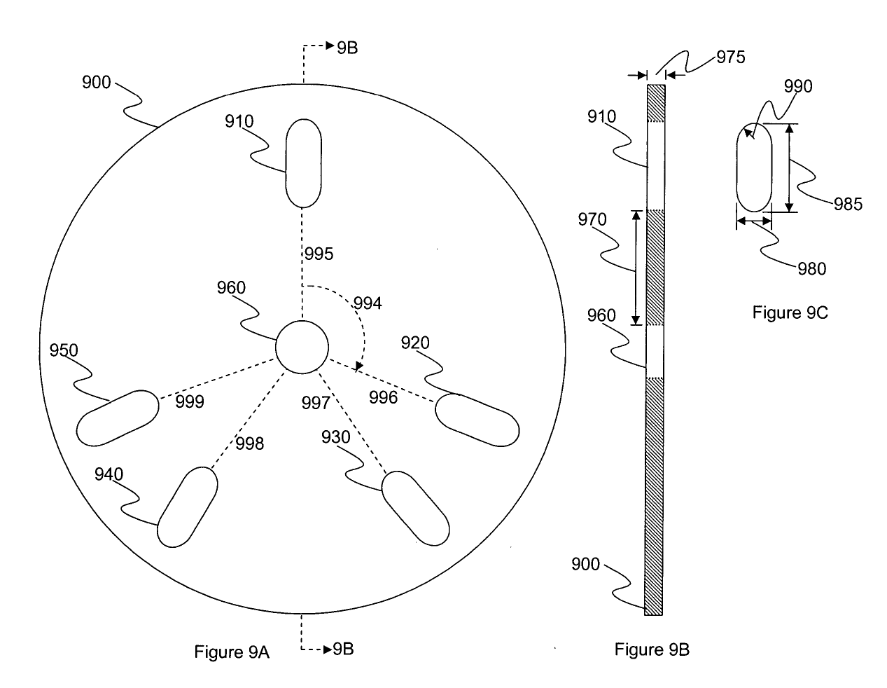

An important advantage of an oscillator assembly in accordance with an exemplary embodiment of the invention is that it can be configured to be universal, meaning that it can be fabricated to accommodate a wide range, possibly all, motor vehicles. Using double-sided lug nuts (such as lug nuts 504 as shown in FIG. 5), existing wheel lugs (such as wheel lugs 502 as shown in FIG. 5), and lug bolts (such as lug bolts 508 as shown in FIG. 508), a universal accessory mount (such as the mount depicted in FIGS. 9A through 9C) may be attached to many, if not all, wheels of passenger vehicles, regardless of make, model or year. This means the universal mount may accommodate wheel lug patterns for U.S. domestic and foreign passenger vehicles, i.e., cars and light trucks. As used herein, universal does not mean the mount will accommodate heavy trucks or industrial vehicles. By way of example, three double-sided lug nuts may be used to engage three wheel lugs to provide a secure attachment. The remaining wheel lugs that are not engaged by the double-sided lug nuts may engage conventional lug nuts to secure the wheel to the vehicle. Thus, so long as three mount apertures 910-950 (that are equidistant from the center of rotation of the mount) may be aligned with the lugs of a wheel, the mount will accommodate the wheel.

Referring now to FIG. 9, a universal accessory mount in accordance with an exemplary implementation of the present invention includes a disc-shaped structure 900, a plurality of oblong apertures 910-950 and a central aperture 960. The oblong apertures are positioned at (or approximately at) the 12, 4, 5, 7 and 8 o'clock positions. Thus, the angle between dotted line 995 and 996 is approximately 120° , between 995 and 997 is approximately 150°, between 995 and 998 is approximately 210° and between 995 and 999 is approximately 240°, all angles being measured in the direction of the arrow 994. The exemplary oblong apertures 910-950 are approximately 30 mm in length 985 and 10 mm in width 980, with a radius at each rounded end equal to approximately one-half of the width 990. The oblong apertures are positioned approximately is 50 mm from the center, measured to the point of the rounded portion of each oblong aperture closest to the center of the mount 900. The mount thickness 975 may be approximately ⅛ inch to ½ inch, though other thicknesses may be used without departing from the scope of the invention.

Those skilled in the art will appreciate that the exemplary universal accessory mount as shown in FIG. 9 may be utilized with each embodiment of the invention described above, as well as with alternative embodiments that incorporate the principles of the present invention. Those skilled in the art will also appreciate that the universal accessory mount may be modified, for example, to accommodate a specific embodiment without departing from the scope of the present invention. By way of example and not limitation, additional apertures may be included, and/or the apertures may have different shapes, sizes and positions. Thus, the mount may be configured to receive a bearing assembly, as mount 775 illustrated in FIG. 7. Alternatively, the mount may include a central collar (such as collar 855 of the mount 870 in FIG. 8) for mounting a bearing assembly. These and other modifications will be readily apparent to those skilled in the art to accommodate specific assemblies according to the principles of the present invention. Such modified mounts come within the scope of the present invention. The universal accessory mount thus provides a means for universal mounting to wheel lugs.

Advantageously, an oscillator assembly in accordance with the principles of the invention may be secured to the lugs of a wheel, therefore obviating the need to remove wheels for installation and removing. Another advantage is that such an oscillator assembly has several points of attachment, rather than one central attachment as in conventional spinner assemblies. Additionally, the oscillator or spinner may be readily changed without requiring removal of the wheels.

Although the foregoing description is directed to preferred embodiments of the invention, it is noted that other variations and modifications will be apparent to those skilled in the art, and may be made without departing from the spirit or scope of the invention.

1. An oscillating wheel assembly configured for attachment to a wheel having a plurality of wheel lugs, said oscillating wheel assembly comprising:
a means for mounting the assembly to two or more of the plurality of wheel lugs;
a means for facilitating rotational motion of an attached structure, said means for facilitating rotational motion being operably coupled to the means for mounting;
an oscillator operably coupled to the means for facilitating rotational motion.

2. An oscillating wheel assembly according to claim 1, wherein the means for mounting includes an accessory mount, said accessory mount having a plurality of apertures near the periphery of the mount, said apertures being sized and configured to receive the plurality of wheel lugs.

3. An oscillating wheel assembly according to claim 1, wherein the means for mounting includes an accessory mount, a universal mount, said universal accessory mount having a plurality of apertures configured to engage two or more wheel lugs of passenger vehicle wheels having different lug patterns.

4. An oscillating wheel assembly according to claim 1, wherein the means for facilitating rotational motion includes a bearing assembly operably coupled to the means for mounting.

5. An oscillating wheel assembly according to claim 1, wherein the oscillator includes a decorative spinner having a plurality of spokes, said oscillator having a diameter less than the diameter of the wheel.

6. An oscillating wheel assembly according to claim 1, further comprising a plurality of weights and means for attaching said plurality of weights to the oscillator.

7. An oscillating wheel assembly according to claim 1, further comprising:
a flange rotatably coupled to the means for facilitating rotational motion, and
a plurality of oscillator mounting bolts, said flange including a plurality of apertures,
said oscillator including a plurality of apertures sized and aligned to correspond with the plurality of apertures of the flange, and configured to receive said plurality of oscillator mounting bolts, said oscillator being attachable to said flange using said oscillator mounting bolts.

8. An oscillating wheel assembly according to claim 7, wherein the plurality of apertures in said flange are threaded and configured for threadedly engaging said plurality of oscillator mounting bolts.

9. An oscillating wheel assembly according to claim 8, further comprising a cap, said cap being attachable to the oscillator and configured to conceal said apertures in said oscillator and said plurality of bolts received in said apertures in said oscillator.

10. An oscillating wheel assembly according to claim 4, further comprising a bearing housing coupled to said means for mounting, said bearing housing including a cavity for receiving said bearing assembly.

11. An oscillating wheel assembly according to claim 10, further comprising:
an axle bolt, said axle bolt having a head and a threaded end, and
an axle nut, said axle nut being configured to threadedly engage the threaded end of the axle bolt,
wherein said means for mounting has a central aperture configured to receive said axle bolt, said bearing assembly has a central aperture in alignment with said central aperture of the means for mounting and configured to receive said axle bolt, said bearing housing has a central aperture configured to receive said axle bolt as received within said bearing assembly, and said axle bolt and axle nut securing said bearing assembly and bearing housing to said means for mounting.

12. An oscillating wheel assembly according to claim 11, wherein said bearing housing further includes a plurality of apertures for receiving bolts for mounting said oscillator.

13. An oscillating wheel assembly configured for attachment to a wheel having a plurality of wheel lugs, said oscillating wheel assembly comprising:
a means for mounting the assembly to two or more of the plurality of wheel lugs;
a means for facilitating rotational motion of an attached structure, said means for facilitating rotational motion being operably coupled to the means for mounting;
an oscillator operably coupled to the means for facilitating rotational motion;
wherein the means for mounting includes an accessory mount, said accessory mount having a plurality of apertures near the periphery of the mount, said apertures being sized and configured to receive a plurality of wheel lugs for a plurality of different lug patterns; and
the means for facilitating rotational motion includes a bearing assembly operably coupled to the means for mounting.

14. An oscillating wheel assembly according to claim 13, wherein the oscillator includes a decorative spinner having a plurality of spokes, said oscillator having a diameter less than the diameter of the wheel.

15. An oscillating wheel assembly according to claim 14, further comprising a plurality of weights and means for attaching said plurality of weights to the oscillator.

16. An oscillating wheel assembly according to claim 15, further comprising:
a flange rotatably coupled to the means for facilitating rotational motion, and
a plurality of oscillator mounting bolts, said flange including a plurality of apertures,
said oscillator including a plurality of apertures sized and aligned to correspond with the plurality of apertures of the flange, and configured to receive said plurality of oscillator mounting bolts, said oscillator being attachable to said flange using said oscillator mounting bolts.

17. An oscillating wheel assembly according to claim 16, wherein the plurality of apertures in said flange are threaded and configured for threadedly engaging said plurality of oscillator mounting bolts.

18. An oscillating wheel assembly according to claim 17, further comprising a cap, said cap being attachable to the oscillator and configured to conceal said apertures in said oscillator and said plurality of bolts received in said apertures in said oscillator.

19. An oscillating wheel assembly according to claim 14, further comprising a bearing housing coupled to said means for mounting, said bearing housing including a cavity for receiving said bearing assembly.

20. An oscillating wheel assembly according to claim 19, further comprising:
an axle bolt, said axle bolt having a head and a threaded end, and
an axle nut, said axle nut being configured to threadedly engage the threaded end of the axle bolt,
wherein said means for mounting has a central aperture configured to receive said axle bolt, said bearing assembly has a central aperture in alignment with said central aperture of the means for mounting and configured to receive said axle bolt, said bearing housing has a central aperture configured to receive said axle bolt as received within said bearing assembly, and said axle bolt and axle nut securing said bearing assembly and bearing housing to said means for mounting.

21. An oscillating wheel assembly according to claim 20, wherein said bearing housing further includes a plurality of apertures for receiving bolts for mounting said oscillator.
